(19) United States
(12) Patent Application Publication
(10) Pub. No.: US 2008/0170003 A1
(43) Pub. Date: Jul. 17, 2008

(54) Plasma display panel

(75) Inventors: Atsuya Ito, Yamanashi (JP); Yasuhiro Torisaki, Yamanashi (JP); Tetsuya Matsumoto, Yamanashi (JP)

Correspondence Address: ARENT FOX LLP, 1050 CONNECTICUT AVENUE, N.W., SUITE 400, WASHINGTON, DC, 20036, US

(73) Assignee: PIONEER CORPORATION

(21) Appl. No.: 11/987,174

(22) Filed: Nov. 28, 2007

(30) Foreign Application Priority Data
Jan. 15, 2007 (JP) 2007-005319
Jan. 24, 2007 (JP) 2007-013645

(51) Int. Cl. G09G 3/28

(52) U.S. Cl. 345/72; 345/60

(57) ABSTRACT

The areas of the transparent electrodes of the row electrodes constituting each row electrode pair facing the required discharge cells vary in accordance with the positions of the corresponding discharge cells within the panel screen. Required column electrodes of a plurality of column electrodes, which are provided for allowing an opposing discharge to be initiated across the discharge space between the column electrode and a row electrode of each row electrode pair in each discharge cell of the PDP, have portions facing the transparent electrodes of the row electrodes and provided with widened portions. The areas of the widened portions vary in accordance with the positions of the corresponding discharge cells within the panel screen.

### BACKGROUND OF THE INVENTION

1. Field of the Invention

This invention relates to the electrode structure of plasma display panels.

The present application claims priority from Japanese Applications No. 2007-005319 and No. 2007-013645, the disclosure of which is incorporated herein by reference.

2. Description of the Related Art

A type of a plasma display panel (hereinafter referred to as “PDP”), which has recently been developed, produces an opposing discharge between a row electrode and a column electrode, besides a surface discharge between two row electrodes constituting each row electrode pair, to generate a luminance gradation display.

However, in general, the in-plane distribution of discharge intensity in the PDP differs between the surface discharge and the opposing discharge. In the opposing discharge, the discharge intensity varies over the panel surface.

It is estimated that the in-plane variations in the opposing discharge are induced by, for example, a spot occurring in the panel surface which is one of the secondary electron emission characteristics of an MgO layer deposited on a dielectric layer overlying the row electrode pairs. In general, the opposing discharge demonstrates a propensity to show a lower intensity in the central portion of the display area of the panel than that in the peripheral portion of the display area.

Accordingly, the PDPs which produce the opposing discharge between the row electrode and the column electrode, in addition to the surface discharge between the row electrodes, to generate a luminance gradation display have the problem of the occurrence of variations in the discharge intensity of the opposing discharge in the panel surface leading to a reduction in display quality of black level luminance, for example.

Conventional PDPs include a type having the areas of the column electrodes facing the row electrodes differing from each other between the red, green and blue discharge cells, as disclosed, for example, in Japanese Unexamined Patent Publication No. 2003-16944; also a type making the column electrodes differ in width in the peripheral portion of the panel as disclosed, for example, in Japanese Unexamined Patent Publication No. 2006-216254. The former PDP is designed to restrain variations in discharge characteristics from occurring due to a difference in charging characteristics between the colors of the red, green and blue phosphor materials forming the phosphor layers provided in the discharge cells. The later PDP is designed to prevent a false discharge or a discharge failure from being caused by the positional misalignment of a column electrode with respect to a discharge cell in the peripheral portion of the display area of the panel.

For this reason, the structure of either the former or the latter PDP is incapable of solving the problem of the disadvantageous reduction in luminance display quality resulting from in-plane variations in discharge intensity of the opposing discharge produced in a PDP which generates a luminance gradation display by means of an opposing discharge initiated between the row electrode and the column electrode as described earlier.

### SUMMARY OF THE INVENTION

It is a technical object of the present invention to overcome the conventional problem in a PDP which produce an opposing discharge between the row electrode and the column electrode to generate a luminance gradation display as described above.

To attain this object, the present invention provides a PDP comprising: a first substrate and a second substrate facing each other across a discharge space to form a panel screen; a plurality of row electrode pairs that extend in a row direction and are regularly arranged in a column direction on a back-facing face of the first substrate, each row electrode pair made up of a first row electrode and a second row electrode; and a plurality of column electrodes that extend in the column direction and regularly arranged in the row direction on a face of the second substrate facing the first substrate to form unit light emission areas in positions respectively corresponding to intersections with the row electrode pairs in the discharge space and are provided for allowing an opposing discharge across the discharge space to be initiated between the column electrodes and the corresponding first row electrodes of the respective row electrode pairs in each unit light emission area. The PDP is characterized in that required column electrode of all the plurality of column electrodes regularly arranged in the row direction have portions facing the corresponding first row electrodes and the portions are set to vary in area in accordance with positions of the corresponding unit light emission areas within the panel screen.

In a best mode for carrying out the PDP according to the present invention, a PDP comprises a front glass substrate and a back glass substrate which face each other across a discharge space and form a panel screen; a plurality of row electrode pairs that extend in a row direction and are regularly arranged in a column direction on a back-facing face of the front glass substrate; and a plurality of column electrodes that extend in the column direction and regularly arranged in the row direction on the face of the back glass substrate facing the front glass substrate to form discharge cells in positions respectively corresponding to the intersections with the row electrode pairs in the discharge space and are provided for allowing an opposing discharge across the discharge space to be initiated between the column electrodes and corresponding row electrodes in the row electrode pairs in each discharge cell. Required column electrodes of all the plurality of column electrodes regularly arranged in the row direction have portions facing corresponding row electrodes in the row electrode pairs and the portions are set to vary in area in accordance with positions of the corresponding discharge cells within the panel screen.

For example, in a PDP in which a black level display is generated only by an opposing discharge initiated between a column electrode and one of a row electrode pair such as a reset discharge and an address discharge (selective erase discharge), the discharge intensity of the opposing discharge may conventionally vary from discharge cell to discharge cell in the panel screen. In this case, in the PDP of the mode according to the present invention, the portions of the required column electrodes of the plurality of column electrodes regularly arranged in the row direction faces the corresponding row electrodes in the row electrode pairs, and the areas of the portions are determined in accordance with the positions of the corresponding discharge cells in the panel screen. As a result, the in-plane variations in discharge intensity of the opposing discharge are corrected, so that the discharge intensity of the opposing discharge can be made approximately uniform over the full panel screen. In consequence, the occurrence of the in-plane spots in the luminance display generated by the opposing discharge is inhibited, thus making it possible to improve the luminance display quality of the PDP.

In the PDP, the opposing area of the column electrode to the corresponding row electrode of the row electrode pair is adjusted to be of a size in accordance with the position of each corresponding discharge cell within the panel screen. Accordingly, as compared with the case of adjusting the opposing area of the row electrode to the column electrode, the discharge intensity of the surface discharge initiated between the row electrodes can be prevented from being affected.

Some possible approaches to the setting of the area of the portion of the column electrode facing the row electrode in the PDP according to the aforementioned mode are described: the portions of the column electrodes facing the corresponding row electrodes in the row electrode pairs may have a largest area in a central portion of the panel screen and may decrease in area by steps from the central portion to a peripheral portion of the panel screen; for example, the panel screen may be divided into three portions, a central portion, an intermediate portion around the central portion, and a peripheral portion around the intermediate portion, and the areas of the portions of the column electrodes facing the corresponding row electrodes in the row electrode pairs in the discharge cells located in the three portions of the panel screen may be set in three sizes decreasing by steps from the central portion to the intermediate portion and then to the peripheral portion; the area of each of the portions of the column electrodes facing the corresponding row electrodes in the row electrode pairs located in the peripheral portion of the panel screen may be smaller than the area of each of the portions of the column electrodes facing the corresponding row electrodes in the row electrode pairs located in the central portion of the panel screen.

In a PDP having in-plane variations in which the discharge intensity of the opposing discharge in the peripheral portion of the panel screen is apt to be lower than that in the central portion, the PDP according to the aforementioned mode is capable of correcting the in-plane variations in discharge intensity of the opposing discharge, thus making the discharge intensity of the opposing discharge approximately uniform over the full panel screen.

In another possible approach to the setting of the area of the portion of the column electrode facing the row electrode in the PDP according to the aforementioned mode, each of the portions of the column electrodes facing the corresponding row electrodes in the row electrode pairs may be provide with a widened portion having a row-direction width larger than that of the remaining portion of the column electrode as appropriate, and the area of the widened portion may be determined to be of a required size.

For example, when each of the row electrodes of each row electrode pair has a row-electrode body extending in the row direction, and a plurality of row-electrode protrusions each extending out from the row-electrode body toward the other row electrode paired therewith in the column direction in a position corresponding to each discharge cell area so as to face the other row electrode across a discharge gap, the widened portion of the column electrode may be formed to face a region including a leading end of each of the row-electrode protrusions close to the discharge gap.

In the PDP according to the aforementioned mode, the discharge cells are be grouped into three types of the discharge cell in which a red phosphor layer is provided, the discharge cell in which a green phosphor layer is provided and the discharge cell in which a blue phosphor layer is provided, these three discharge cells forming a pixel. The portions of the column electrodes facing the corresponding row electrodes in the row electrode pairs, located facing the discharge cells each having the phosphor layer of one of the three colors provided therein from among these three discharge cells, are set to vary in area in accordance with positions of the corresponding discharge cells within the panel screen. Some possible approaches to the setting for this are described. For example, the column electrode facing the discharge cells in which the red phosphor layers are provided alone may be subjected to the above setting. The column electrode facing the discharge cells in which the green phosphor layers are provided alone may be subjected to the above setting. Alternatively, The column electrodes facing both the discharge cells in which the red phosphor layers are provided and the discharge cells in which the green phosphor layers are provided may be subjected to the above setting. In this case, the portions of the column electrode facing the corresponding row electrodes in the row electrode pairs, in the discharge cells in which the blue phosphor layers are respectively provided, may have a uniform area. Still alternatively, all the column electrodes may be subjected to the above setting.

Specifically, the discharge characteristics differ depending on the red, green and blue phosphor materials forming the phosphor layers. Therefore, in each of the discharge cells in which the phosphor layer having a color causing a wide range of in-plane variations in the discharge intensity of the opposing discharge are provided, the area of the portion of the column electrode facing the row electrode of the row electrode pair is determined in accordance with the in-plane variations of the discharge intensity. In consequence, the discharge intensity of the opposing discharge can be made approximately uniform over the full panel screen.

Further, in a best mode for carrying out the PDP according to the present invention, a PDP comprises a first substrate and a second substrate which face each other across a discharge space and form a panel screen; a plurality of row electrode pairs that extend in a row direction and are regularly arranged in a column direction on a back-facing face of the first substrate; and a plurality of column electrodes that extend in the column direction and regularly arranged in the row direction on the face of the second substrate facing the first substrate to form discharge cells in positions respectively corresponding to the intersections with the row electrode pairs in the discharge space and are provided for allowing an opposing discharge across the discharge space to be initiated between the column electrodes and corresponding row electrodes in the row electrode pairs in each discharge cell. Each of the row electrodes constituting each row electrode pair has discharge-initiating portions, and the discharge-initiating portions facing required discharge cells of all the discharge cells are set to vary in area in accordance with positions of the corresponding unit light emission areas within the panel screen. Required column electrodes of all the plurality of column electrodes regularly arranged in the row direction have portions each of which faces the discharge-initiating portion of the row electrode of the row electrode pair and the portions are set to vary in area with respect to the area of the discharge-initiating portions of the row electrodes in accordance with positions of the corresponding discharge cells within the panel screen.

In a PDP in which a low gradation display, for example, a black level display and the like, is generated by an opposing discharge initiated between a column electrode and one of a row electrode pair, the discharge intensity of the opposing discharge may conventionally vary from discharge cell to discharge cell in the panel screen. In this case, in the PDP of the mode according to the present invention, the discharge-initiating portions of the row electrodes constituting the row electrode pairs facing the required discharge cells, and the portions of the required column electrodes of the plurality of column electrodes regularly arranged in the row direction facing the corresponding discharge-initiating portions of the row electrodes in the row electrode pairs, are determined to vary in areas in accordance with the positions of the corresponding discharge cells in the panel screen. Thus, the opposing area between each of the discharge-initiating portions of the row electrode and the portion of the column electrode facing this discharge-initiating portion of the row electrode is set to be larger in the discharge cells in which the discharge intensity of the opposing discharge is low, and also to be smaller in the discharge cells in which the discharge intensity of the opposing discharge is high, in accordance with the position of the corresponding discharge cell within the panel screen. As a result, the in-plane variations in discharge intensity of the opposing discharge are corrected, so that the discharge intensity of the opposing discharge can be made approximately uniform over the full panel screen. In consequence, the occurrence of the in-plane spots in the luminance display generated by the opposing discharge is inhibited, thus making it possible to improve the luminance display quality of the PDP.

Some possible approaches to the setting of the areas of the discharge-initiating portion of the row electrode and the portion of the column electrode facing the discharge-initiating portion of the row electrode in the PDP according to the aforementioned mode are described: the discharge-initiating portions of the row electrodes and the portions of the column electrodes may both have largest areas in a central portion of the panel screen and may decrease in area by steps from the central portion to a peripheral portion of the panel screen; for example, the panel screen may be divided into three portions, a central portion, an intermediate portion around the central portion, and a peripheral portion around the intermediate portion, and the areas of the discharge-initiating portions of the row electrode and the portions of the column electrodes facing the corresponding discharge-initiating portions of the row electrodes in the discharge cells located in the three portions of the panel screen may be set in three sizes decreasing by steps from the central portion to the intermediate portion and then to the peripheral portion.

In a PDP having in-plane variations in which the discharge intensity of the opposing discharge in the peripheral portion of the panel screen is apt to be lower than that in the central portion, the PDP according to the aforementioned mode is capable of correcting the in-plane variations in discharge intensity of the opposing discharge, thus making the discharge intensity of the opposing discharge approximately uniform over the full panel screen.

A possible approach to the setting of the area of the discharge-initiating portion of the row electrode in the PDP according to the aforementioned mode is described. Each of the row electrodes has a row-electrode body extending in the row direction, and a plurality of row-electrode protrusions each of which extends out from the row-electrode body toward the other row electrode paired therewith in the column direction in a position corresponding to each unit light emission area so as to face the other row electrode across a discharge gap and forms the discharge-initiating portion. In the row electrode, the row-electrode protrusions facing the required discharge cells from among the plurality of row-electrode protrusions may be set to vary in area in accordance with the positions of the corresponding discharge cells within the panel screen.

Also, in a possible approach to the setting of the area of the portion of the column electrode facing the row electrode, each of the portions of the column electrodes facing the corresponding discharge-initiating portion of the row electrode may be provide with a widened portion having a row-direction width larger than that of the remaining portion of the column electrode as appropriate, and the area of the widened portion may be determined to be of a required size.

For example, when each of the row electrodes of each row electrode pair has a row-electrode body extending in the row direction, and a plurality of row-electrode protrusions each extending out from the row-electrode body toward the other row electrode paired therewith in the column direction in a position corresponding to each discharge cell area so as to face the other row electrode across a discharge gap, the widened portion of the column electrode may be formed to face a region including a leading end of each of the row-electrode protrusions close to the discharge gap.

In the PDP according to the aforementioned mode, the discharge cells are be grouped into three types of the discharge cell in which a red phosphor layer is provided, the discharge cell in which a green phosphor layer is provided and the discharge cell in which a blue phosphor layer is provided, these three discharge cells forming a pixel. The discharge-initiating portions of the row electrodes and the portions of the column electrodes facing the discharge-initiating portions of the row electrodes, which are located facing the discharge cells each having the phosphor layer of one of the three colors provided therein from among these three discharge cells, are set to vary in area in accordance with positions of the corresponding discharge cells within the panel screen. Some possible approaches to the setting for this are described. For example, the discharge-initiating portions of the row electrodes and the column electrodes facing the discharge cells in which the red phosphor layers are provided alone may be subjected to the above setting. The discharge-initiating portions of the row electrodes and the column electrodes facing the discharge cells in which the green phosphor layers are provided alone may be subjected to the above setting. Alternatively, the discharge-initiating portions of the row electrodes and the column electrodes facing both the discharge cells in which the red phosphor layers are provided and the discharge cells in which the green phosphor layers are provided may be subjected to the above setting. In this case, the discharge-initiating portions of the row electrodes and the portions of the column electrodes facing the row electrode which are located facing the discharge cells in which the blue phosphor layers are respectively provided may have a uniform area. Still alternatively, all the discharge-initiating portions of the row electrodes and the column electrodes may be subjected to the above setting.

Specifically, the discharge characteristics differ depending on the red, green and blue phosphor materials forming the phosphor layers. Therefore, in each of the discharge cells in which the phosphor layer having a color causing a wide range of in-plane variations in the discharge intensity of the opposing discharge are provided, the areas of the discharge-initiating portion of the row electrode and the portion of the column electrode facing the row electrode is determined in accordance with the in-plane variations of the discharge intensity. In consequence, the discharge intensity of the opposing discharge can be made approximately uniform over the full panel screen.

These and other objects and features of the present invention will become more apparent from the following detailed description with reference to the accompanying drawings.

### BRIEF DESCRIPTION OF THE DRAWINGS

FIG. 1 is a diagram illustrating the discharge intensity distribution of an opposing discharge in the panel display area of a PDP.

FIG. 2 is a front view illustrating the panel structure of a central portion of the panel display area in a first embodiment of a PDP according to the present invention.

FIG. 3 is a front view illustrating the panel structure of an intermediate portion of the panel display area in the first embodiment.

FIG. 4 is a front view illustrating the panel structure of a peripheral portion of the panel display area in the first embodiment.

FIG. 5 is a sectional view taken along the V-V line in FIG. 2.

FIG. 6 is a front view illustrating the panel structure of a central portion of the panel display area in a second embodiment of a PDP according to the present invention.

FIG. 7 is a front view illustrating the panel structure of a intermediate portion of the panel display area in the second embodiment.

FIG. 8 is a front view illustrating the panel structure of a peripheral portion of the panel display area in the second embodiment.

FIG. 9 is a front view illustrating the panel structure of a central portion of the panel display area in a third embodiment of a PDP according to the present invention.

FIG. 10 is a front view illustrating the panel structure of a central portion of the panel display area in a fourth embodiment of a PDP according to the present invention.

FIG. 11 is a front view illustrating the panel structure of a central portion of the panel display area in a fifth embodiment of a PDP according to the present invention.

FIG. 12 is a front view illustrating the panel structure of a central portion of the panel display area in a sixth embodiment of a PDP according to the present invention.

FIG. 13 is a front view illustrating the panel structure of a central portion of the panel display area in a seventh embodiment of a PDP according to the present invention.

FIG. 14 is a front view illustrating the panel structure of a central portion of the panel display area in an eighth embodiment of a PDP according to the present invention.

### DETAILED DESCRIPTION OF THE PREFERRED EMBODIMENTS

### First Embodiment

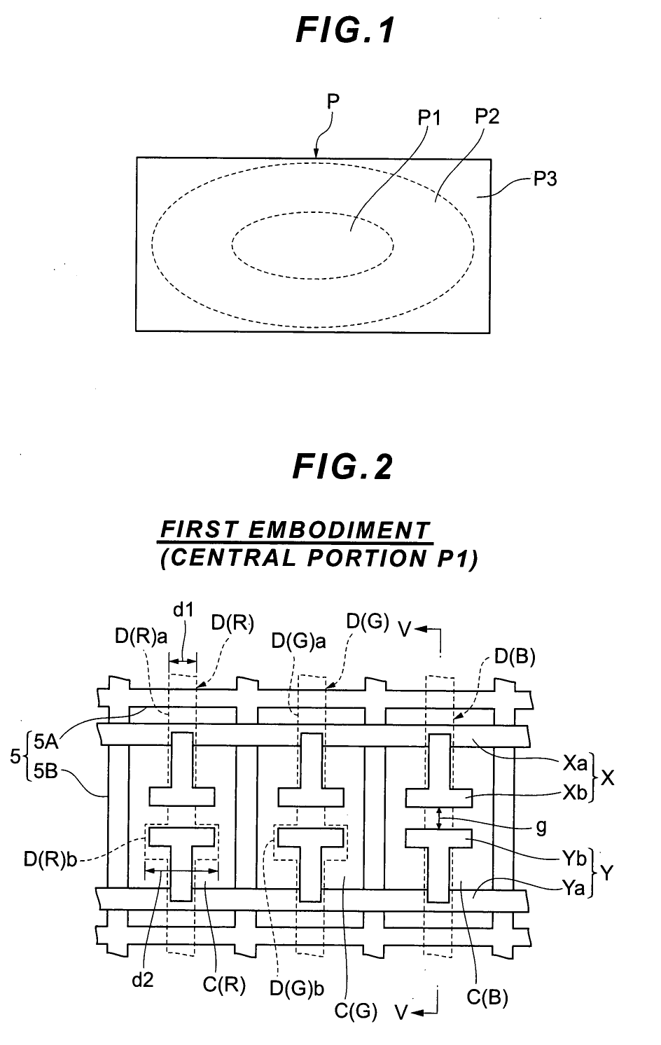

A description will be given of a PDP that produces an opposing discharge between a row electrode and a column electrode having a discharge intensity distribution in the panel display area as shown in FIG. 1, by way of example.

FIG. 1 shows the panel display area P, in which the discharge intensity of the opposing discharge in an elliptic central portion P1 is weakest, the discharge intensity of the opposing discharge in an elliptic ring-shaped intermediate portion P2 around the central portion P1 is stronger than that in the central portion P1, and the discharge intensity of the opposing discharge in a peripheral portion P3 around the intermediate portion P2 in the panel display area P is strongest.

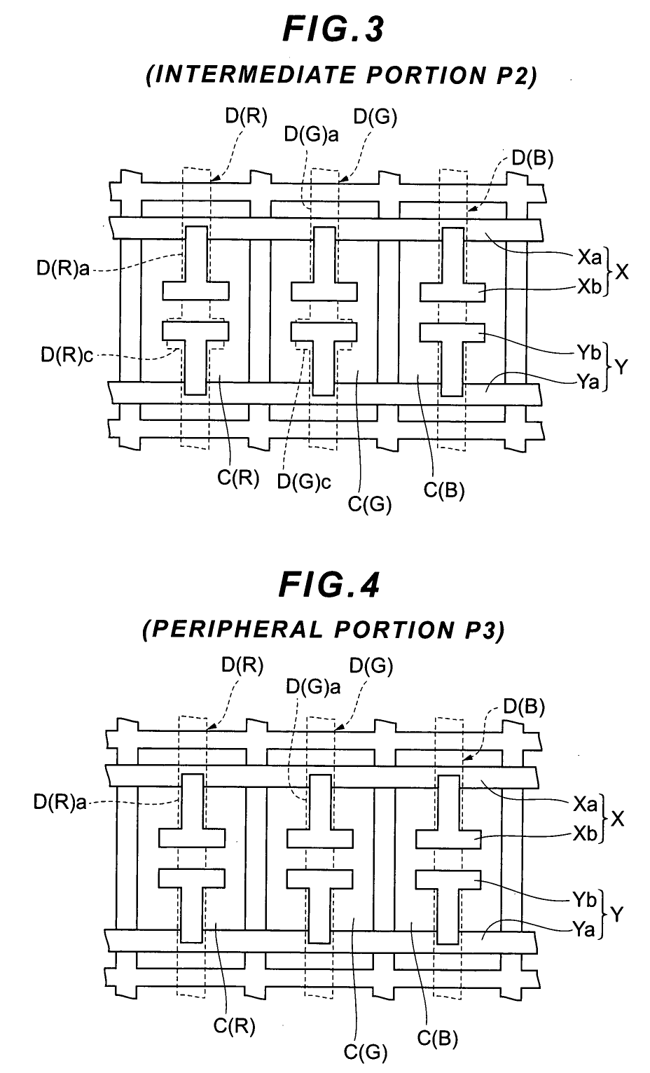

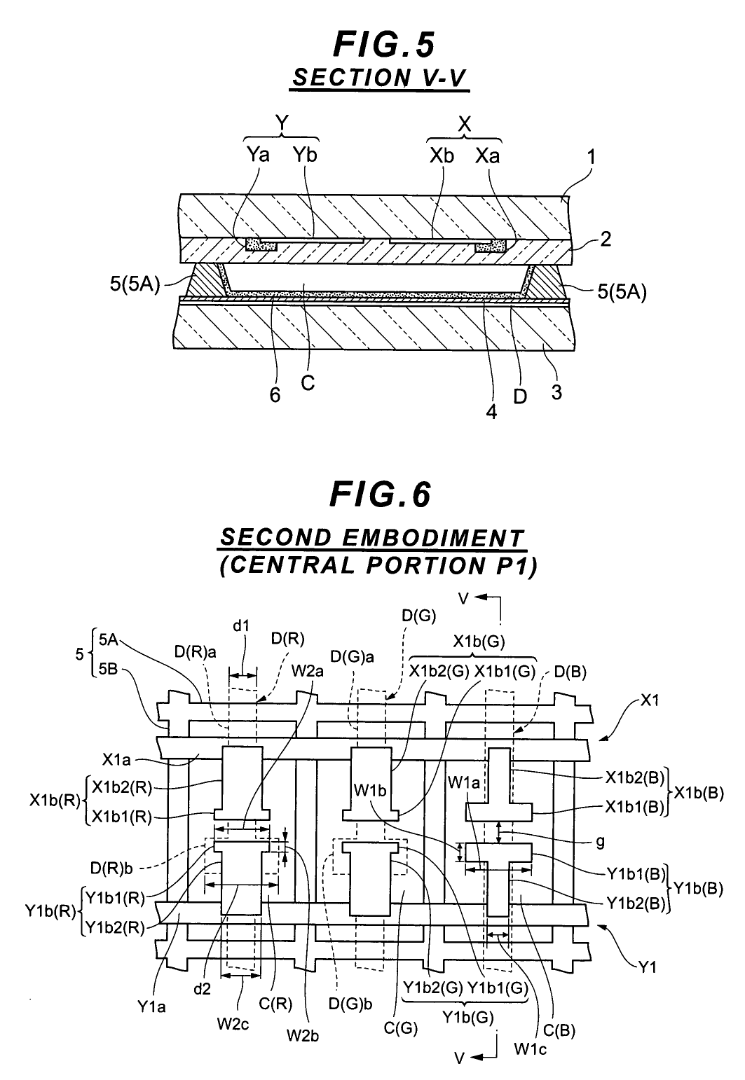

FIG. 2 to FIG. 5 illustrate a first embodiment of the PDP according to the present invention. FIG. 2 is a front view illustrating the panel structure of the central portion P1 (see FIG. 1) of the panel display area P of the PDP. Likewise, FIG. 3 is a front view illustrating the panel structure of the intermediate portion P2 of the panel display area P. FIG. 4 is a front view illustrating the panel structure of the peripheral portion P3 of the panel display area P. FIG. 5 is a sectional view taken along the V-V line in FIG. 2.

In FIG. 2 to FIG. 5, the PDP includes a front glass substrate 1 serving as the display surface, and a plurality of row electrode pairs (X, Y) which each extend in the row direction of the front glass substrate 1 (in the right-left direction in FIGS. 2 to 4) and which are regularly arranged on the back-facing face (facing the rear of the PDP) of the front glass substrate 1 in the column direction (the vertical direction in FIGS. 2 to 4).

Each of the row electrodes X is composed of a bus electrode Xa formed of a metal film extending in the row direction of the front glass substrate 1, and T-shaped transparent electrodes Xb formed of a transparent conductive film made of ITO or the like. The transparent electrodes Xb are arranged at equal distance from each other and connected to the bus electrode Xa so as to extend out from the bus electrode Xa in the column direction.

Likewise, each of the row electrodes Y is composed of a bus electrode Ya formed of a metal film extending in the row direction of the front glass substrate 1, and T-shaped transparent electrodes Yb formed of a transparent conductive film made of ITO or the like. The transparent electrodes Yb are arranged at equal distance from each other and connected to the bus electrode Ya so as to extend out from the bus electrode Ya in the column direction.

The row electrodes X and Y are arranged in alternate positions in the column direction of the front glass substrate 1 (the vertical direction in FIGS. 2 to 4). Each of the transparent electrodes Xb and Yb, which are regularly spaced along the associated bus electrodes Xa and Ya facing each other, extends out toward its counterpart in the row electrode pair, so that the wide distal ends of the transparent electrodes Xb and Yb face each other across a discharge gap g having a required width.

In addition, a dielectric layer 2 is deposited on the back-facing face of the front glass substrate 1 so as to overlie the row electrode pairs (X, Y). In turn, a protective layer, not shown, is deposited on the back-facing face of the dielectric layer 2 so as to overlie the back-facing face of the dielectric layer 2.

The front glass substrate 1 is placed parallel to a back glass substrate 3 across the discharge space. A plurality of column electrodes D are arranged parallel to each other at predetermined intervals on the face of the back glass substrate 3 facing the front glass substrate 1. Each of the column electrodes D extends in a direction at right angles to the bus electrodes Xa, Ya (i.e. in the column direction) on a portion of the back glass substrate 3 opposite to the paired transparent electrodes Xb and Yb of each row electrode pair (X, Y).

The structure of the column electrode D will be described in detail later.

In addition, a column-electrode protective layer (dielectric layer) 4 is deposited on the face of the back glass substrate 3 facing the front glass substrate 1 so as to overlie the column electrodes D, and in turn a partition wall unit 5 having a shape as described below is formed on the column-electrode protective layer 4.

The partition wall unit 5 is formed in an approximate grid shape made up of transverse walls 5A and vertical walls 5B. Each of the transverse walls 5A extends in the row direction on a portion of the column-electrode protective layer 4 facing an area between the back-to-back bus electrodes Xa and Ya of the adjacent row electrode pairs (X, Y) when viewed from the front glass substrate 1. Each of the vertical walls 5B extends in the column direction on a portion of the column-electrode protective layer 4 facing an area between the adjacent transparent electrodes Xb and also between the adjacent transparent electrodes Yb which are arranged at regular intervals along the corresponding bus electrodes Xa, Ya of the row electrodes X, Y.

The partition wall unit 5 partitions the discharge space defined between the front glass substrate 1 and the back glass substrate 3 into areas each facing the opposing and paired transparent electrodes Xb, Yb to form discharge cells C.

A phosphor layer 6 is formed on the five faces facing the discharge space in each discharge cell C: the four side faces of the transverse walls 5A and the vertical walls 5B of the partition wall unit 5 and the face of the column-electrode protective layer 4. The colors of the phosphor layers 6 in the respective discharge cells C are disposed such that red, green and blue colors are arranged in order in the row direction one to each discharge cell C. As shown in FIGS. 2 to 4, a pixel is constituted of three discharge cells C which are arranged adjacent to each other in the row direction: a red discharge cell C(R) in which a red phosphor layer 6 is provided, a green discharge cell C(G) in which a green phosphor layer 6 is provided and a blue discharge cell C(B) in which a blue phosphor layer 6 is provided.

In the first embodiment, the red discharge cells C(R), the green discharge cells C(G) and the blue discharge cells C(B) are disposed such that the discharge cells C of the same color are arranged in the column direction.

The discharge cells C are filled with a discharge gas that includes xenon.

Next, the structure of the column electrode D in the central portion P1, the intermediate portion P2 and the peripheral portion P3 of the panel display area P will be described.

Each of the column electrodes D(B) faces the blue discharge cells C(B) adjacent to each other and forming a line in the column direction. The column electrode D(B) is formed in a bar shape with an equal width in the row direction in all of the central portion P1, the intermediate portion P2 and the peripheral portion P3 of the panel display area P1.

Each of the column electrodes D(R) faces the red discharge cells C(R) forming a line in the column direction. A portion of the column electrode D(R) corresponding to the central portion P1 of the panel display area P as shown in FIG. 2 has widened portions D(R)b corresponding respectively to the red discharge cells C(R). Each of the widened portion D(R)b faces the leading wide-end of the transparent electrode Yb of the row electrode in each red discharge cell C(R). The widened portion D(R)b has a row-direction width d2 longer than the row-direction width d1 of the column-electrode body D(R)a which extends in a bar shape in the column direction.

A portion of the column electrode D(R) corresponding to the intermediate portion P2 of the panel display area P as shown in FIG. 3 has widened portions D(R)c each facing the leading wide-end of the transparent electrode Yb of the row electrode in each red discharge cell C(R). The area of the widened portion D(R)c is smaller than that of the widened portion D(R)b corresponding to the central portion P1.

What is required for the widened portion D(R)c is to have a smaller opposing area to the transparent electrode Yb (i.e. the area of the widened portion facing the transparent electrode) than that of the widened portion D(R)b located in the central portion P1. For this purpose, both or either of the row-direction width and/or the column-direction width of the widened portion D(R)c may be smaller than those of the widened portion D(R)b (in the example in FIG. 3, the widened portion corresponding to the intermediate portion P2 is smaller in width in both the row direction and the column direction than that corresponding to the central portion P1).

A portion of the column electrode D(R) corresponding to the peripheral portion P3 of the panel display area P as shown in FIG. 4 is composed of the column-electrode body D(R)a having the row-direction width d1 without a widened portion corresponding to each red discharge cell C(R) as formed in the central portion P1 and the intermediate portion P2.

Each of the column electrodes D(G) faces the green discharge cells C(G) forming a line in the column direction. Like the column electrode D(R), a portion of the column electrode D(G) corresponding to the central portion P1 of the panel display area P has widened portions D(G)b corresponding respectively to the green discharge cells C(G). Each of the widened portion D(G)b faces the leading wide-end of the transparent electrode Yb of the row electrode in each green discharge cell C(G). The widened portion D(G)b has a row-direction width longer than the row-direction width of the column-electrode body D(G)a which extends in a bar shape in the column direction.

A portion of the column electrode D(G) corresponding to the intermediate portion P2 of the panel display area P as shown in FIG. 3 has widened portions D(G)c each facing the leading wide-end of the transparent electrode Yb of the row electrode in each green discharge cell C(G). The area of the widened portion D(G)c is smaller than that of the widened portion D(G)b corresponding to the central portion P1.

What is required for the widened portion D(G)c is to have a smaller opposing area to the transparent electrode Yb than that of the widened portion D(G)b located in the central portion P1. For this purpose, both or either of the row-direction width and/or the column-direction width of the widened portion D(G)c may be smaller than those of the widened portion D(G)b (in the example in FIG. 3, the widened portion corresponding to the intermediate portion P2 is smaller in width in both the row direction and the column direction than that corresponding to the central portion P1).

A portion of the column electrode D(G) corresponding to the peripheral portion P3 of the panel display area P as shown in FIG. 4 is composed of the column-electrode body D(G)a having the row-direction width without a widened portion corresponding to each green discharge cell C(G) as formed in the central portion P1 and the intermediate portion P2.

The widened portions D(G)b and D(G)c of the column electrode D(G) may be identical in the row-direction width and the column-direction width with the respective widened portions D(R)b and D(R)c of the column electrode D(R). Desirably, the size of the widened portion of each of the column electrodes D(G) and D(R) is determined in accordance with the discharge characteristics of the red/green phosphor material forming the phosphor layer 6 facing the column electrode.

For the operation of the PDP, a reset pulse is applied to the row electrodes Y to initiate a reset discharge, which is an opposing discharge, simultaneously between the row electrodes Y and the column electrodes D(R), D(G), D(B) in the discharge cells C(R), C(G), C(B), resulting in the accumulation or elimination of the wall charge on or from the portions of the dielectric layer facing the discharge cells so as to initialize all the discharge cells.

Next, a scan pulse is applied to the row electrodes Y and a data pulse is selectively applied to the column electrodes D(R), D(G), D(B) to initiate an address discharge, which is an opposing discharge, between the transparent electrode Yb of the row electrode Y and each of the corresponding column electrodes D(R), D(G) and D(B). The address discharge results in the distribution of the light-emission cells in which the wall charge is accumulated on the portions of the dielectric layer 2 facing the discharge cells and the non-light-emission cells in which the wall charge is eliminated from the dielectric layer 2, over the panel display area P of the panel in accordance with the image data of the video signal.

Then, a sustaining pulse is applied alternately to the row electrodes X and Y in each row electrode pair (X, Y). Thereupon, because of the wall charge accumulation on the dielectric layer 2 in each of the light-emission cells, a sustaining discharge, which is a surface discharge, is initiated across the discharge gap g between the transparent electrodes Xb and Yb of the row electrodes X and Y. The sustaining discharge results in the generation of vacuum ultraviolet light from the xenon in the discharge gas, which thus excites the phosphor layer 6. Thus, the excited phosphor layers 6 of the three primary colors, red, green, blue, in the light-emission cells emit visible light so as to form the matrix display image on the panel display area.

In the operation of the PDP as described above, a timing and intensity for the application of the reset pulse, the scan pulse and the data pulse are determined as appropriate. Thereby, the reset discharge and the address discharge, which are opposing discharges and are produced between each of the column electrodes D(R), D(G), D(B) and the corresponding transparent electrode Yb of the row electrode Y, successfully cause the phosphor layer 6 to emit visible light for a low gradation display, such as a black level luminance display.

In this regard, if the opposing area of the column electrode to the row electrode, between which the opposing discharge is produced, is equal over the panel surface, a uniform low-gradation display cannot be achieved over the full panel surface. This is because in-plane variations in the opposing discharge are estimated to be caused by, for example, a spot occurring in the panel surface which is one of the secondary electron emission characteristics of the protective layer (MgO layer) overlying the dielectric layer as described earlier.

In the PDP of the embodiment, the column electrodes D(R) and D(G) have the widened portions D(R)b and D(G)b facing the transparent electrodes Yb of the row electrodes Y in the central portion P1 of the panel display area P (see FIG. 1) in which the intensity of the opposing discharge is weakest. Accordingly, the opposing area of the column electrode to the transparent electrode Yb in the central portion P1 is larger than that in the peripheral portion P3. In the intermediate portion P2 in which the intensity of the opposing discharge is weaker than in the peripheral portion P3 and stronger than in the central portion P1, the column electrodes D(R) and D(G) have the widened portions D(R)c and D(G)c facing transparent electrodes Yb and having an smaller opposing area to the transparent electrode Yb than that of the widened portion D(R)b, D(G)b in the central portion P1. Accordingly, the column electrode has an opposing area in the central portion P1 larger than in the peripheral portion P3 and smaller than in the central portion P1.

The size of each of the widened portions D(R)b, D(G)b, D(R)c and D(G)c of the column electrodes D(R) and D(G) is determined as appropriate so as to ensure an approximately uniform discharge intensity of the opposing discharge (reset discharge, address discharge) initiated between the column electrode D and the transparent electrode Yb of the row electrode Y over the full panel display area P.

Thus, the in-plane variations in discharge intensity of the opposing discharge in the panel display area P are corrected, so that the discharge intensity of the opposing discharge between each of the column electrodes D(R), D(G) and D(B) and the transparent electrode Yb of the row electrode Y is made approximately uniform over the full panel display area P. As a result, the occurrence of the in-plane spots in the luminance display (in particular, low-degradation display such as in black level luminance) generated by the opposing discharge is inhibited, thus making it possible to improve the luminance display quality of the PDP.

In the PDP, the opposing area of the column electrode to the transparent electrode Yb is adjusted to be of a size in accordance with the discharge intensity of the opposing discharge in each portion of the panel display area P. Accordingly, as compared with the case of adjusting the opposing area of the row electrode to the column electrode, the discharge intensity of the sustaining discharge, which is the surface discharge initiated between the row electrodes, has no possibility of being affected by the uniformity of the discharge intensity of the opposing discharge.

In the PDP, the widened portion is provided only to the column electrodes D(R) and D(G) facing the red discharge cells C(R) and the green discharge cells C(G), and is not provided to the column electrode D(B) facing the blue discharge cells C(B). The reason for this is described. The in-plane variations of the discharge intensity of the opposing discharge produced between the row electrode Y and the column electrode D(B) in the blue discharge cell C(B) occur within the panel display area P. The in-plane variations in the blue discharge cell C(B) is much narrower than those in the red discharge cell C(R) and the green discharge cell C(G) because of the discharge characteristics of the blue phosphor material forming the phosphor layer 6 assigned to the blue discharge cell C(B).

However, if the discharge intensity of the opposing discharge produced between the row electrode Y and the column electrode D in the blue discharge cell C(B) varies considerably from location to location, the column electrode D(B) may be provided with widened portions as in the case of the column electrodes D(R) and D(G), as described later.

In the first embodiment the panel display area P is divided into three portions as shown in FIG. 1 and the widened portions are formed on the column electrode in accordance with the three individual portions. However, the first embodiment is not limited to this example. The panel display area P may be divided into two portions or four or more portions and the column electrode may have widened portions correspondingly formed in accordance with the divided portions.

The greater the number of divided portions of the panel display area P, the greater the increase in the uniformity of the discharge intensity of the opposing discharge over the full panel surface, resulting in an improvement in the quality of the luminance gradation display.

### Second Embodiment

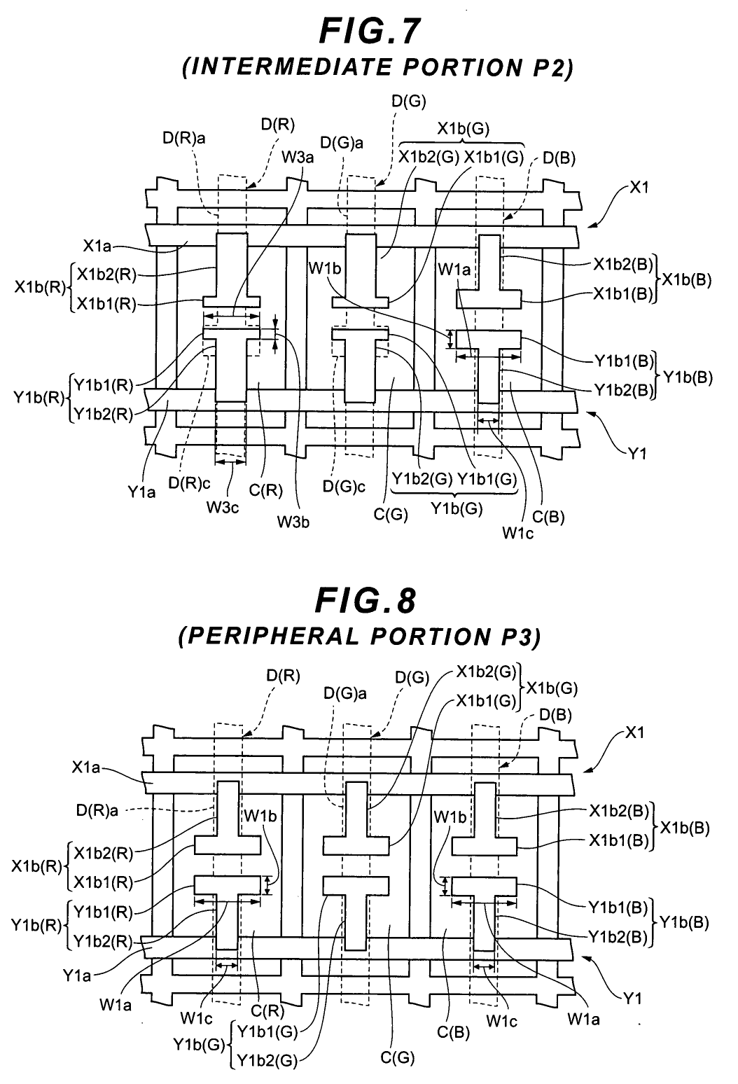

FIG. 6 to FIG. 8 illustrate a PDP of a second embodiment of the present invention. FIG. 6 is a front view showing the panel structure in the central portion P1 of the panel display area P of the PDP. Similarly, FIG. 7 is a front view showing the panel structure in the intermediate portion P2 of the panel display area P, and FIG. 8 is a front view showing the panel structure in the peripheral portion P3 of the panel display area P (see FIG. 1).

Apart from the transparent electrode of the row electrode, the structure of the components of the PDP of the second embodiment is approximately the same as that of the PDP of the foregoing first embodiment. The components of the same structure are designated in FIG. 6 to FIG. 8 with the same reference numerals as those in the first embodiment.

In FIG. 6 to FIG. 8, the transparent electrodes X1b, Y1b in the row electrode X1, Y1 are each formed approximately in a T shape made up of the leading ends X1b1, Y1b1 facing each other across the discharge gap g and the base ends X1b2, Y1b2 connected to the corresponding bus electrodes X1a, Y1a. The row-direction width of each of the leading ends X1b1, Y1b1 is larger than that of the base end X1b2, or Y1b2.

The transparent electrodes X1b(B), Y1b(B) from among the transparent electrodes X1b, Y1b regularly spaced along the corresponding bus electrodes X1a, Y1a face the blue discharge cells C(B) arranged in the column direction. The row-direction width W1a and the column-direction width W1b of each of the leading ends X1b1(B), Y1b1(B), and the row-direction width W1c of each of the base ends X1b2(B), Y1b2(B) are determined equally in all the central portion P1, the intermediate portion P2 and the peripheral portion P3 of the panel display area P. Accordingly, the leading ends X1b1(B), Y1b1(B) and the base ends X1b2(B), Y1b2(B) are all equal in area over the panel display area P.

Referring to FIG. 6, in the central portion P1 of the panel display area P, the transparent electrodes X1b(R), Y1b(R) face the red discharge cells C(R). The transparent electrodes X1b(G), Y1b(G) face the green discharge cells C(G). The area of each of the transparent electrodes X1b(R), Y1b(R), X1b(G), Y1b(G) is larger than that of each of the transparent electrodes X1b(B), Y1b(B) facing the blue discharge cell C(B).

In the example illustrated in FIG. 6, specifically, the transparent electrodes X1b(R), Y1b(R) face the red discharge cell C(R) and the transparent electrodes, X1b(G), Y1b(G) face the green discharge cell C(G). The transparent electrodes X1b(R), Y1b(R), X1b(G), Y1b(G) respectively have the leading ends X1b1(R), Y1b1(R), X1b1(G), Y1b1(G). Both the row-direction width W2a and the column-direction width W2b of each of the leading ends X1b1(R), Y1b1(R), X1b1(G), Y1b1(G) are smaller than the row-direction width W1a and the column-direction width W1b of each of the leading ends X1b1(B), Y1b1(B) of the respective transparent electrodes X1b(B), Y1b(B) facing the blue discharge cell C(B). However, the row-direction width W2c of each of the base ends X1b2(R), Y1b2(R), X1b2(G), Y1b2(G) is larger than the row-direction width W1c of each of the base ends X1b2(B), Y1b2(B) of the transparent electrode X1b(B), Y1b(B) (W2c>W1c). Accordingly the area of each of the transparent electrodes X1b(R), Y1b(R), X1b(G), Y1b(G) is greater than the area of each of the transparent electrodes X1b(B), Y1b(B).

In the intermediate portion P2 of the panel display area P shown in FIG. 7, each of the transparent electrodes X1b(R), Y1b(R) facing the red discharge cell C(R) and each of the transparent electrodes X1b(G), Y1b(G) facing the green discharge cell C(G) have an area smaller than those in the central portion P1, but greater than that of each of the transparent electrodes X1b(B), Y1b(B) facing the blue discharge cell C(B).

In the example illustrated in FIG. 7, specifically, both the row-direction width W3a and the column-direction width W3b of each of the leading ends X1b1(R), Y1b1(R), X1b1(G), Y1b1(G) of the respective transparent electrodes X1b(R), Y1b(R), X1b(G), Y1b(G) are smaller than the row-direction width W1a and the column-direction width W1b of each of the leading ends X1b1(B), Y1b1(B) of the respective transparent electrodes X1b(B), Y1b(B), but are greater than the row-direction W2a and the column-direction width W2b in the central portion P1. However, the row-direction width W3c of each of the base ends X1b2(R), Y1b2(R), X1b2(G), Y1b2(G) is larger than the row-direction width W1c of each of the base ends X1b2(B), Y1b2(B) of the transparent electrode X1b(B), Y1b(B), but smaller than the row-direction width W2c in the central portion P1 (W2c>W3c>W1c). Accordingly the area of each of the transparent electrodes X1b(R), Y1b(R), X1b(G), Y1b(G) in the intermediate portion P2 is smaller than the area thereof in the central portion P1, but greater than the area of each of the transparent electrodes X1b(B), Y1b(B).

In the peripheral portion P3 of the panel display area P shown in FIG. 8, the transparent electrodes X1b(R), Y1b(R) facing the red discharge cell C(R) and the transparent electrodes X1b(G), Y1b(G) facing the green discharge cell C(G) are identical in area with the transparent electrodes X1b(B), Y1b(B) facing the blue discharge cell C(B). Specifically, all the row-direction and the column-direction widths of the leading ends X1b1(R), Y1b1(R), X1b1(G), Y1b1(G) of the respective transparent electrodes X1b(R), Y1b(R), X1b(G), Y1b(G), and also the row-direction width of the base ends X1b2(R), Y1b2(R), X1b2(G), Y1b2(G) are respectively equal to the row-direction width W1a and the column-direction width W1b of the leading ends X1b2(B), Y1b2(B) of the transparent electrodes X1b(B), Y1b(B), and the row-direction width W1c of the base ends X1b2(B), Y1b2(B).

The structure of the column electrodes D in the central portion P1, the intermediate portion P2 and the peripheral portion P3 of the panel display area P are the same as that in the first embodiment.

For the operation of the PDP, a reset pulse is applied to the row electrodes Y1 to initiate a reset discharge, which is an opposing discharge, simultaneously between the row electrodes Y and the column electrodes D(R), D(G), D(B) in the discharge cells C(R), C(G), C(B), resulting in the accumulation or elimination of the wall charge on or from the portions of the dielectric layer facing the discharge cells so as to initialize all the discharge cells.

Next, a scan pulse is applied to the row electrodes Y1 and a data pulse is selectively applied to the column electrodes D(R), D(G), D(B) to initiate an address discharge, which is an opposing discharge, between the transparent electrode Y1b of the row electrode Y1 and each of the corresponding column electrodes D(R), D(G), D(B). The address discharge results in the distribution of light-emission cells in which the wall charge is accumulated on the portions of the dielectric layer 2 (see FIG. 5) facing the discharge cells and non-light-emission cells in which the wall charge is eliminated from the dielectric layer 2, over the panel display area P of the panel in accordance with the image data of the video signal.

Then, a sustaining pulse is applied alternately to the row electrodes X1 and Y1 in each row electrode pair (X1, Y1). Thereupon, because of the wall charge accumulation on the dielectric layer 2 in each of the light-emission cells, a sustaining discharge, which is a surface discharge, is initiated across the discharge gap g between the transparent electrodes X1b and Y1b of the row electrodes X1 and Y1. The sustaining discharge results in the generation of vacuum ultraviolet light from the xenon in the discharge gas, which thus excites the phosphor layer 6 (see FIG. 5). Thus, the excited phosphor layers 6 of the three primary colors, red, green, blue, in the light-emission cells emit visible light so as to form the matrix display image on the panel display area.

In the operation of the PDP as described above, the reset pulse, the scan pulse and the data pulse are applied at a timing and intensity which are determined as appropriate. Thereby, the reset discharge and the address discharge, which are opposing discharges, and are produced between each of the column electrodes D(R), D(G), D(B) and the corresponding transparent electrode Y1b of the row electrode Y1, cause the phosphor layer 6 to emit visible light for a low gradation display, such as a black level luminance display.

In this regard, if the opposing area of the column electrode to the row electrode, between which the opposing discharge is produced, is equal over the panel surface, a uniform low-gradation display cannot be achieved over the full panel surface. This is because in-plane variations in the opposing discharge are estimated to be caused by, for example, a spot occurring in the panel surface which is one of the secondary electron emission characteristics of the protective layer (MgO layer) overlying the dielectric layer as described earlier.

In the PDP of the embodiment, the widened portions D(R)b and D(G)b of the column electrodes D(R) and D(G) respectively face the leading ends of the transparent electrodes Y1b(R) and Y1b(G) in the central portion P1 of the panel display area P (see FIG. 1) in which the intensity of the opposing discharge is weakest. Accordingly, the opposing areas of the column electrodes D(R), D(G) to the corresponding transparent electrodes Y1b(R), Y1b(G) in the central portion P1 are respectively larger than those in the peripheral portion P3.

In the intermediate portion P2 in which the intensity of the opposing discharge is weaker than in the peripheral portion P3 and stronger than in the central portion P1, the widened portions D(R)c, D(G)c of the column electrodes D(R), D(G) respectively face the leading ends of the transparent electrodes Y1b(R), Y1b(G). Accordingly, the opposing areas of the column electrodes D(R), D(G) to the corresponding transparent electrodes Y1b(R), Y1b(G) in the intermediate portion P2 are respectively smaller than those in the central portion P1, and larger than those in the peripheral portion P3.

The respective opposing areas between the leading ends of the transparent electrodes Y1b(R), Y1b(G) of the row electrodes Y1(R), Y1(G) to the widened portions D(R)b, D(G)b, D(R)c, D(G)c of the column electrodes D(R), D(G) are determined as appropriate so as to ensure an approximately uniform discharge intensity of the opposing discharge (the reset discharge, the address discharge) initiated between the column electrodes D and the transparent electrodes Y1b of the row electrodes Y1 over the full panel display area P.

Thus, the in-plane variations in discharge intensity of the opposing discharge in the panel display area P are corrected, so that the discharge intensity of the opposing discharge between each of the column electrodes D(R), D(G) and D(B) and the corresponding transparent electrode Y1b of the row electrode Y1 is made approximately uniform over the full panel display area P. As a result, the occurrence of the in-plane spots in the luminance display (in particular, low-degradation display such as in the black level luminance) generated by the opposing discharge is inhibited, thus making it possible to improve the luminance display quality of the PDP.

In the PDP, the transparent electrodes Yb(B) facing the blue discharge cells C(B) are formed equally in size (area) in all of the central portion P1, the intermediate portion P2 and the peripheral portion P3. Further, the widened portion is not provided to the column electrode D(B) facing the blue discharge cells C(B). The reason for this is as follows. The in-plane variations of the discharge intensity of the opposing discharge produced between the row electrodes Y1(B) and the column electrodes D(B) in the blue discharge cells C(B) in the panel display area P, are made much narrower than those in the red discharge cell C(R) and the green discharge cell C(G), by the discharge characteristics of the blue phosphor material forming the phosphor layer 6 assigned to the blue discharge cell C(B).

However, if the opposing discharge produced between the row electrodes Y1 and the column electrodes D(B) in the blue discharge cells C(B) varies considerably in discharge intensity, the transparent electrodes Y1b(B) may be shaped in increasing size from the peripheral portion P3 through the intermediate portion P2 to the central portion P1. Alternatively, the column electrode D(B) may be provided with widened portions as in the case of the column electrodes D(R) and D(G), as described later.

In the second embodiment, the panel display area P is divided into three portions as shown in FIG. 1. Then, in accordance with the three individual portions, each of the areas of the transparent electrodes X1b, Y1b of the row electrodes X1, Y1 is determined and widened portions are formed on the column electrode. However, the second embodiment is not limited to this example. The panel display area P may be divided into two portions or four or more portions. Then, the transparent electrodes X1b, Y1b of the row electrodes X1, Y1 may have areas correspondingly determined in accordance with the divided portions, and similarly/or alternatively, the column electrodes may have widened portions correspondingly formed in accordance with the divided portions.

The greater the number of divided portions of the panel display area P, the greater the increase in the uniformity of the discharge intensity of the opposing discharge over the full panel surface, resulting in an improvement in the quality of the luminance gradation display.

In the second embodiment, the transparent electrodes Y1b(R) and Y1b(G) of the row electrodes Y1(R) and Y1(G) are designed to be identical with each other in size (area) in the central portion P1 and the intermediate portion P2, but may be designed to differ in size (area) in accordance with the discharge characteristics of the red and green phosphor materials forming the respective phosphor layers 6 corresponding thereto.

Similarly, in the second embodiment, the widened portions D(R)b and D(G)b of the column electrodes D(R) and D(G) are designed to be identical in size (area) in the central portion P1 and also the widened portions D(R)c and D(G)c are designed to be identical in size (area) in the intermediate portion P2. However, the widened portions D(R)b and (G)b, and equally, the widened portions D(R)c and D(G)c, may differ in size (area) from each other in accordance with the discharge characteristics of the red and green phosphor materials forming the respective phosphor layers 6 corresponding thereto.

In the second embodiment, what is required for the widened portions D(R)c, D(G)c of the column electrodes D(R), D(G) is to have a smaller opposing area to the transparent electrode Yb than that of widened portions D(R)b, D(G)b. For this purpose, both or either of the row-direction width and the column-direction width of the widened portions of D(R)c, D(G)c may be required to be smaller than the row-direction width and/or the column-direction width of the widened portions of D(R)b, D(G)b in the central portion P1 (in the example shown in FIGS. 6 to 8, both of the row-direction width and the column-direction width of the widened portions of D(R)c, D(G)c are smaller than those in the central portion P1).

### Third Embodiment

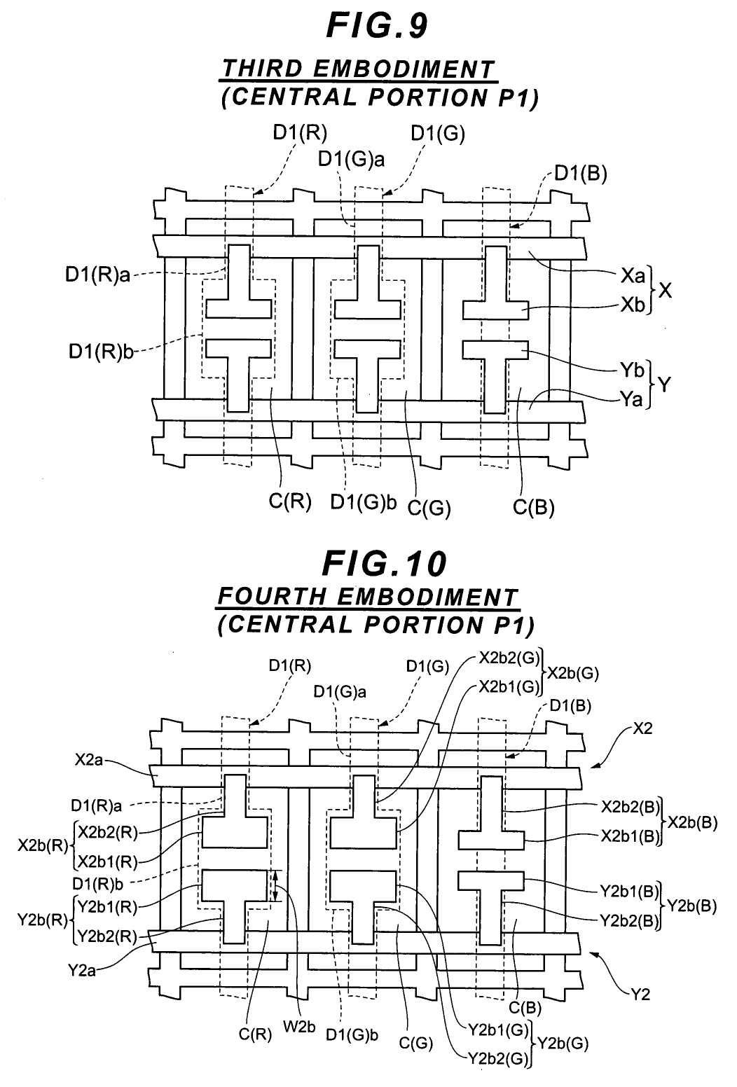

FIG. 9 is a schematic front view illustrating the panel structure in the central portion P1 of the panel display area P (see FIG. 1) of a PDP in a third embodiment of the present invention.

In the PDP illustrated in the foregoing first embodiment the column electrodes D(R), D(G) have widened portions formed in the portions facing the transparent electrodes Yb of the row electrodes Y. On the other hand, in the PDP illustrated in the third embodiment each of the widened portions of each of the column electrodes D1(R), D1(G) is formed in a size corresponding to the transparent electrode Xb of the row electrode X as well as the transparent electrode Yb of the row electrode Y.

Referring to FIG. 9, specifically, the column electrodes D1(R) and D1(G), which respectively extend along the red discharge cells C(R) and the green discharge cells C(G) arranged in the column direction, have widened portions D1(R)b, D1(G)b formed in the portions respectively facing the red and green discharge cells C(R), C(G) in the central portion P1 of the panel display area P. The widened portions D1(R)b, D1(G)b have a row-direction width longer than that of the corresponding main bodies D1(R)a, D1(G)a which extend in a bar shape in the column direction. Each of the widened portions D1(R)b, D1(G)b faces the wide leading end of the transparent electrode Xb of the row electrode X as well as the wide leading end of the transparent electrode Yb of the row electrode Y in each discharge cell.

In the intermediate portion P2 of the panel display area P (see FIG. 1), the column electrodes D1(R), D1(G) also have widened portions formed in the portions (not shown) respectively facing the red and green discharge cells C(R), C(G). The widened portions in the intermediate portion P2 are smaller in area than those in the central portion P1.

In the peripheral portion P3 of the panel display area P (see FIG. 1), the portions of the column electrodes D1(R), D1(G) respectively facing the red discharge cell C(R) and the green discharge cell C(G) are each composed only of main bodies D1(R)a, D1(G)a with an unchanging row-direction width, as in the case of the first embodiment.

Over the full panel display area P including the central portion P1, the intermediate portion P2 and the peripheral portion P3, each of the blue column electrodes D1(B), which faces the adjacent blue discharge cells C(B) in the column direction, is formed in a bar shape with an unchanging row-direction width, as in the case of the first embodiment.

The structure of other components of the PDP, the setting of the areas of the widened portions of the column electrodes D1(R), D1(G) in the central portion P1 and the intermediate portion P2 of the panel display area P, and the like in the third embodiment are the same as those in the first embodiment.

Similarly, in this PDP, the in-plane variations in discharge intensity of the opposing discharge in the panel display area P are also corrected by providing widened portions on the column electrodes D1(R), D1(G). Thereby, the discharge intensity of the opposing discharge between the column electrodes D1(R), D1(G) and D1(B) and the corresponding transparent electrodes Yb of the row electrodes Y is made approximately uniform over the full panel display area P. As a result, the occurrence of in-plane spots in the luminance display (in particular, low-degradation display such as in the black level luminance) generated by the opposing discharge is inhibited, thus making it possible to improve the luminance display quality of the PDP.

In the PDP according to the embodiment, the opposing area of the column electrode to the transparent electrode Yb is adjusted to be of a size in accordance with the discharge intensity of the opposing discharge in each portion of the panel display area P. Accordingly, as compared with the case of adjusting the opposing area of the row electrode to the column electrode, the discharge intensity of the sustaining discharge, which is the surface discharge initiated between the row electrodes, has no possibility of being affected by the uniformity of the discharge intensity of the opposing discharge.

### Fourth Embodiment

FIG. 10 is a schematic front view illustrating the panel structure in the central portion P1 of the panel display area P (see FIG. 1) of a PDP in a fourth embodiment of the present invention.

In the PDP illustrated in the foregoing second embodiment the column electrodes D(R), D(G) have widened portions formed in the portions facing the transparent electrodes Y1b of the row electrodes Y1. On the other hand, in the PDP illustrated in the fourth embodiment each of the widened portions of the column electrodes D1(R), D1(G) is formed in a size corresponding to the transparent electrode X2b(R), or X2b(G), of the row electrode X2 as well as the transparent electrode Y2b(R), or Y2b(G), of the row electrode Y2.

Referring to FIG. 10, specifically, the column electrodes D1(R) and D1(G), which extend respectively along the red discharge cells C(R) and the green discharge cells C(G) arranged in the column direction, have widened portions D1(R)b, D1(G)b formed in the portions respectively facing the red and green discharge cells C(R), C(G) in the central portion P1 of the panel display area P. The widened portions D1(R)b, D1(G)b have a row-direction width longer than that of the corresponding main bodies D1(R)a, D1(G)a which extend in a bar shape in the column direction. Each of the widened portions D1(R)b faces both the wide leading end of the transparent electrode Y2b(R) of the row electrode Y2 and the wide leading end of the transparent electrode X2b(R) of the row electrode X2 in each discharge cell, and likewise each of the widened portions D1(G)b faces both the wide leading end of the transparent electrode Y2b(G) and the wide leading end of the transparent electrode X2b(G).

In the intermediate portion P2 of the panel display area P (see FIG. 1), the column electrodes D1(R), D1(G) also have widened portions formed in portions (not shown) respectively facing the red and green discharge cells C(R), C(G). Each of the widened portions of the column electrode D1(R) faces the leading ends of the respective transparent electrodes X2b(R) and Y2b(R). Each of the widened portions of the column electrode D1(G) faces the leading ends of the respective transparent electrodes X2b(G) and Y2b(G). These widened portions in the intermediate portion P2 are smaller in area than those in the central portion P1.

In the peripheral portion P3 of the panel display area P (see FIG. 1), portions (not shown) of the column electrodes D1(R), D1(G) respectively facing the red discharge cell C(R) and the green discharge cell C(G) are each composed only of the main bodies D1(R)a, D1(G)a with an unchanging row-direction width, as in the case of the second embodiment.

Over the full panel display area P including the central portion P1, the intermediate portion P2 and the peripheral portion P3, each of the blue column electrodes D1(B), which faces the adjacent blue discharge cell C(B) in the column direction, is formed in a bar shape with an unchanging row-direction width, as in the case of the second embodiment.

As in the case of the second embodiment, the size (area) of the transparent electrodes X2b(R), Y2b(R), X2b(G), Y2b(G) of the row electrodes X2, Y2 is largest in the central portion P1 of the panel display area P, and decreases by steps in the intermediate portion P2 and the peripheral portion P3.

In the example described in the fourth embodiment, the leading ends X2b1(R), Y2b1(R), X2b1(G), Y2b1(G) of the transparent electrodes X2b(R), Y2b(R), X2b(G), Y2b(G) differ only in the size of the column-direction width W2b from one portion to another of the three portions of the panel display area P, so that the area of the transparent electrodes X2b(R), Y2b(R), X2b (G), Y2b (G) is larger than that of the transparent electrodes X2b(B), Y2b(B) in the central portion P1 and the peripheral portion P2, and also decreases by steps from the central portion P1 through the intermediate portion P2 to the peripheral portion P3.

The structure of other components of the PDP, the setting of the areas of the transparent electrodes X2b(R), Y2b(R), X2b (G), Y2b(G) and the widened portions of the column electrodes D1(R), D1(G) in the central portion P1 and the intermediate portion P2 of the panel display area P, and the like in the fourth embodiment are the same as those in the second embodiment.

Similarly, in this PDP, the in-plane variations in discharge intensity of the opposing discharge in the panel display area P are also corrected by increasing the opposing area between the transparent electrodes Y2b(R), Y2b(G) and the widened portions on the column electrodes D1(R), D1(G) by steps from the peripheral portion P3 to the intermediate portion P2 and then to the central portion P1. Thereby, the in-plane variations in discharge intensity of the opposing discharge in the panel display area P is corrected, and thus the discharge intensity of the opposing discharge produced between the column electrodes D1(R), D1(G), D1(B) and the corresponding row electrodes Y2(R), Y2(G), Y2(B) is made approximately uniform over the full panel display area P. As a result, the occurrence of in-plane spots in the luminance display (in particular, low-degradation display such as in the black level luminance) generated by the opposing discharge is inhibited, thus making it possible to improve the luminance display quality of the PDP.

### Fifth Embodiment

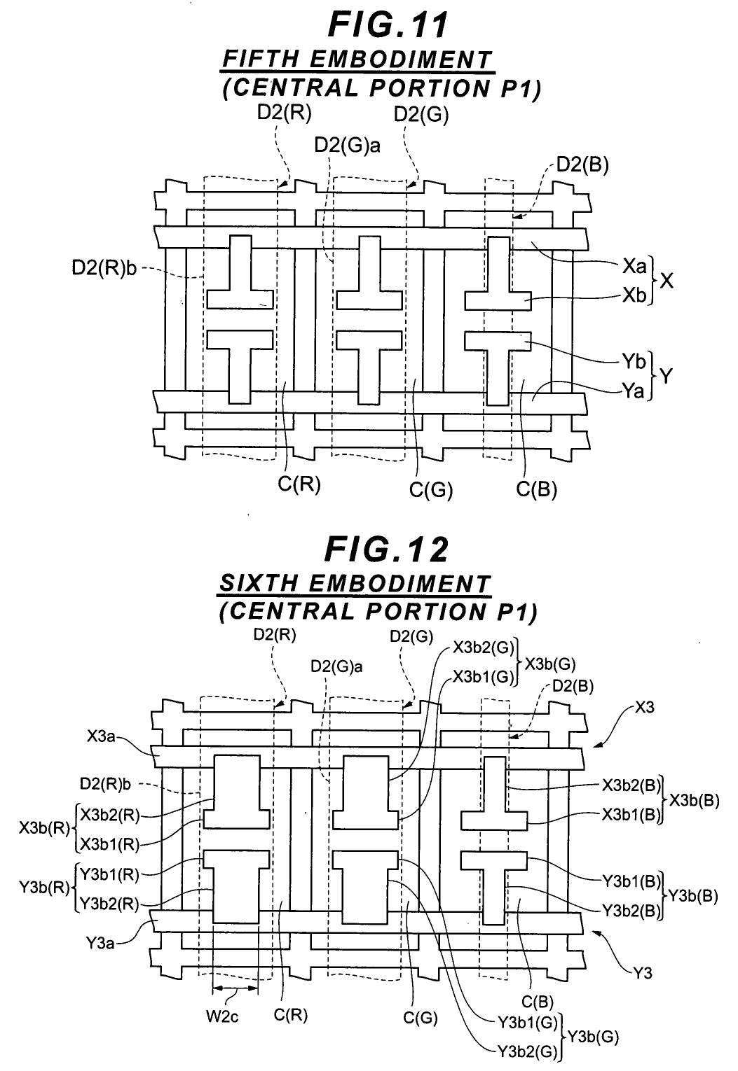

FIG. 11 is a schematic front view illustrating the panel structure in the central portion P1 of the panel display area P (see FIG. 1) of a PDP in a fifth embodiment of the present invention.

In the PDP illustrated in the foregoing first embodiment the column electrodes D(R), D(G) have widened portions formed in the portions facing the transparent electrodes Yb of the row electrodes Y. On the other hand, in the PDP illustrated in the fifth embodiment, column electrodes D2(R), D2(G) have portions respectively facing the red and green discharge cells C(R), C(G) in the central portion P1 of the panel display area P, and the entire portions are respectively composed of widened portions D2(R)b, D2(G)b having a row-direction width greater than that of widened portions of the column electrodes D2(R), D2(G) in the peripheral portion P3 of the panel display panel P.

Likewise, in the intermediate portion of the panel display area P (see FIG. 1), portions (not shown) of the column electrodes D2(R), D2(G) respectively facing the red and green discharge cells C(R), C(G) are entirely composed of respective widened portions having a row-direction width smaller than that in the central portion P1.

In the periphery portion P3 of the panel display area P (see FIG. 1), portions of the column electrodes D2(R), D2(G) respectively facing the red and green discharge cells C(R), C(G) are composed of respective main bodies having an unchanging row-direction width, as in the case of the first embodiment.

As in the case of the first embodiment, each of the column electrodes D2(B) facing the blue discharge cells C(B) arranged in the column direction is formed in a bar shape having an unchanging row-direction width over the full panel display area P1 including the central portion P1, the intermediate portion P2 and the peripheral portion P3.

The structure of other components of the PDP, the setting of the areas of the widened portions of the column electrodes D2(R), D2(G) in the central portion P1 and the intermediate portion P2 of the panel display area P, and the like in the fifth embodiment are the same as those in the first embodiment.

Similarly, in this PDP, the in-plane variations in discharge intensity of the opposing discharge in the panel display area P are also corrected by providing widened portions on the column electrodes D2(R), D2(G). Thereby, the discharge intensity of the opposing discharge between the column electrodes D2(R), D2(G) and D2(B) and the corresponding transparent electrodes Yb of the row electrodes Y is made approximately uniform over the full panel display area P. As a result, the occurrence of in-plane spots in the luminance display (in particular, low-degradation display such as in the black level luminance) generated by the opposing discharge is inhibited, thus making it possible to improve the luminance display quality of the PDP.

In the PDP according to the embodiment, the opposing area of the column electrode to the transparent electrode Yb is adjusted to be of a size in accordance with the discharge intensity of the opposing discharge in each portion of the panel display area P. Accordingly, as compared with the case of adjusting the opposing area of the row electrode to the column electrode, the discharge intensity of the sustaining discharge, which is the surface discharge initiated between the row electrodes, has no possibility of being affected by the uniformity of the discharge intensity of the opposing discharge.

### Sixth Embodiment

FIG. 12 is a schematic front view illustrating the panel structure in the central portion P1 of the panel display area P (see FIG. 1) of a PDP in a sixth embodiment of the present invention.

In the PDP illustrated in the foregoing second embodiment the column electrodes D(R), D(G) have widened portions formed in the portions facing the transparent electrodes Yb of the row electrodes Y. On the other hand, in the PDP illustrated in the sixth embodiment, column electrodes D2(R), D2(G) have portions respectively facing the red and green discharge cells C(R), C(G) in the central portion P1 of the panel display area P, and the portions are entirely composed of respective widened portions D2(R)b, D2(G)b having a row-direction width greater than that of the widened portions of the column electrodes D2(R), D2(G) in the peripheral portion P3 of the panel display panel P.

Likewise, in the intermediate portion of the panel display area P (see FIG. 1), portions (not shown) of the column electrodes D2(R), D2(G) respectively facing the red and green discharge cells C(R), C(G) are entirely composed of respective widened portions having a row-direction width smaller than that in the central portion P1 and larger than that in the peripheral portion P3.

In the periphery portion P3 of the panel display area P (see FIG. 1), portions (not shown) of the column electrodes D2(R), D2(G) respectively facing the red and green discharge cells C(R), C(G) are composed of respective main bodies having a row-direction width equal to the row-direction width of a column electrode D2(B) facing the blue discharge cells C(B), as in the case of the first embodiment.

As in the case of the second embodiment, each of the column electrodes D2(B) facing the blue discharge cells C(B) arranged in the column direction is formed in a bar shape having an unchanging row-direction width over the full panel display area P1 including the central portion P1, the intermediate portion P2 and the peripheral portion P3.

As in the case of the second embodiment, the size (area) of transparent electrodes X3b(R), Y3b(R), X3b(G), Y3b(G) of the row electrodes X3, Y3 is largest in the central portion P1 of the panel display area P, and decreases by steps in the intermediate portion P2 and then the peripheral portion P3.

In the example described in the sixth embodiment, base ends X3b2(R), Y3b2(R), X3b2(G), Y3b2(G) of the transparent electrodes X3b(R), Y3b(R), X3b(G), Y3b(G) differ only in the size of the column-direction width W2c from one portion to another of the three portions of the panel display area P, so that the area of the transparent electrodes X3b(R), Y3b(R), X3b(G), Y3b(G) is larger than that of the transparent electrodes X3b(B), Y3b(B) in the central portion P1 and the peripheral portion P2, and also decreases by steps from the central portion P1 through the intermediate portion P2 to the peripheral portion P3.

The structure of other components of the PDP, the setting of the areas of the transparent electrodes X3b(R), Y3b(R), X3b (G), Y3b (G) and the widened portions of the column electrodes D2(R), D2(G) in the central portion P1 and the intermediate portion P2 of the panel display area P, and the like in the sixth embodiment are the same as those in the first embodiment.

Similarly, in this PDP, the in-plane variations in discharge intensity of the opposing discharge in the panel display area P are also corrected by increasing the opposing area between each of the transparent electrodes Y3b(R), Y3b(G) and the corresponding one of the widened portions on the column electrodes D2(R), D2(G) by steps from the central portion P1 through the intermediate portion P2 to the peripheral portion P3. Thereby, the discharge intensity of the opposing discharge produced between the column electrodes D2(R), D2(G) and D2(B) and the corresponding row electrodes Y3(R), Y3(G), Y3(B) is made approximately uniform over the full panel display area P. As a result, the occurrence of in-plane spots in the luminance display (in particular, low-degradation display such as in the black level luminance) generated by the opposing discharge is inhibited, thus making it possible to improve the luminance display quality of the PDP.

### Seventh Embodiment

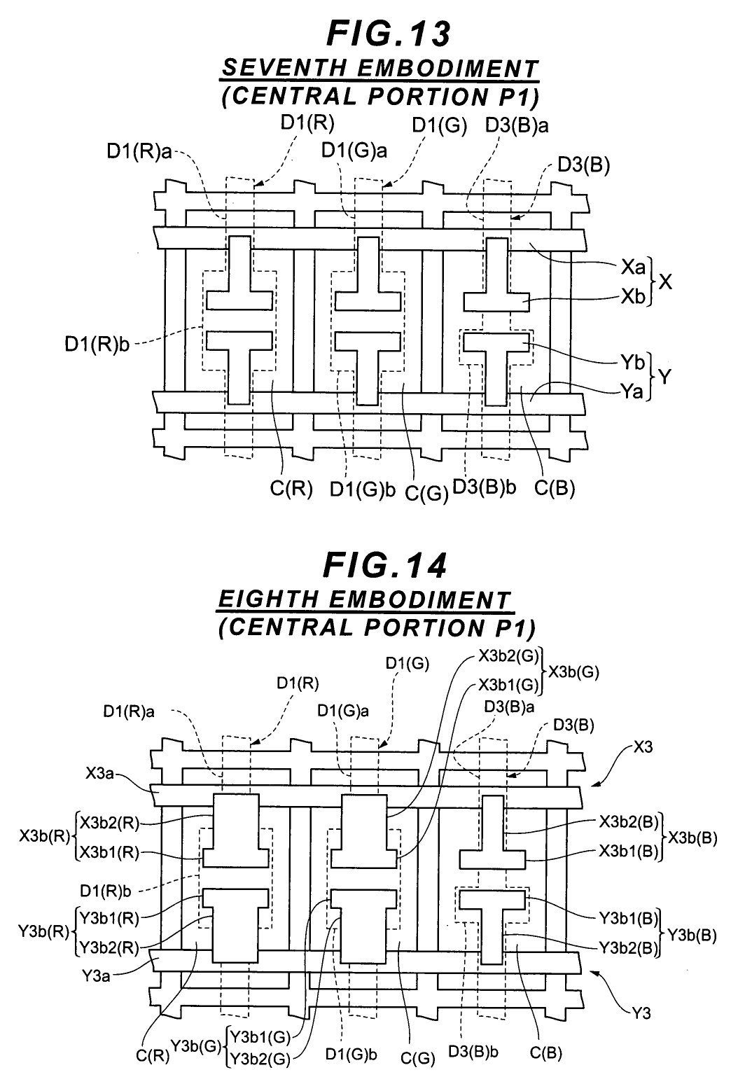

FIG. 13 is a schematic front view illustrating the panel structure in the central portion P1 of the panel display area P (see FIG. 1) of a PDP in a seventh embodiment of the present invention.

In the PDP illustrated in each of the foregoing first, third and fifth embodiments the widen portions are provided only on the column electrodes D(R), D(G). On the other hand, in the PDP illustrated in the seventh embodiment the widened portions are provided on each of the column electrodes facing the blue discharge cells C(B) as well.

Referring to FIG. 13, specifically, the column electrode D3(B), which extends along the blue discharge cells C(B) arranged in the column direction, has widened portions D3(B)b formed in the portions respectively facing the blue discharge cells C(B) in the central portion P1 of the panel display area P. Each of the widened portions D3(B)b has a row-direction width longer than that of the main body D3(B)a which extend in a bar shape in the column direction. The widened portion D3(B)b faces the wide leading end of the transparent electrode Yb of the row electrode Y in each blue discharge cell.

The column electrode D3(B) has widened portions respectively formed in portions (not shown) facing the blue discharge cells C(B) in the intermediate portion P2 of the panel display area P (see FIG. 1). Each of the widened portions in the intermediate portion P2 are smaller in area than that of the column electrode D3(B) in the central portion P1.

A portion (not shown) of the column electrode D3(B) facing the blue discharge cells C(B) in the peripheral portion P3 of the panel display area P (see FIG. 1) is composed only of the main body D3(B)a with an unchanging row-direction width.

As for the other column electrodes facing the red discharge cells C(R) and the green discharge cells C(G), FIG. 13 illustrates the same column electrodes D1(R), D1(G) as those described in the third embodiment. However, the column electrodes facing the red discharge cells C(R) and the green discharge cells C(G) in the seventh embodiment may be either the same column electrodes D(R), (D) G as those described in the first embodiment or the same column electrodes D2(R), D2(G) as those described in the fifth embodiment.

The structure of other components of the PDP, the setting of the areas of the widened portions of the column electrode D3(B) in the central portion P1 and the intermediate portion P2 of the panel display area P, and the like in the seventh embodiment are similar to the structure, and the setting for the column electrodes D(R), D(G), and the like in the first embodiment.

The PDP of the seventh embodiment can deliver the same technical advantages as those in the PDP according to the first, third and fifth embodiments. In addition, even if the discharge intensity of the opposing discharge produced between the row electrode Y and the column electrode D3(B) in the blue discharge cell C(B) varies considerably from location to location in the PDPs of the first, third and fifth embodiments, the PDP of the seventh embodiment can ensure uniform intensities of the opposing discharge initiated in the blue discharge cells C(B) over the full panel display area P.

### Eighth Embodiment

FIG. 14 is a schematic front view illustrating the panel structure in the central portion P1 of the panel display area P (see FIG. 1) of a PDP in an eighth embodiment of the present invention.

In the PDP illustrated in each of the foregoing second, fourth and sixth embodiments the widen portions are provided only on the column electrodes D(R), D(G). On the other hand, in the PDP illustrated in the eighth embodiment the widened portions are provided on each of the column electrodes facing the blue discharge cells C(B) as well.

Referring to FIG. 14, specifically, each of the column electrodes D3(B), which extends along the blue discharge cells C(B) arranged in the column direction, has widened portions D3(B)b formed in the portions respectively facing the blue discharge cells C(B) in the central portion P1 of the panel display area P. Each of the widened portions D3(B)b has a row-direction width longer than that of the main body D3(B)a which extend in a bar shape in the column direction. The widened portion D3(B)b faces both the leading end, including the wide leading end Y3b1(B), of the transparent electrode Y3b(B) of the row electrode Y3 in each blue discharge cell.

The column electrode D3(B) has widened portions respectively formed in portions (not shown) facing the blue discharge cells C(B) in the intermediate portion P2 of the panel display area P (see FIG. 1). Each of the widened portions in the intermediate portion P2 are smaller in area than that of the column electrode D3(B) in the central portion P1.

A portion (not shown) of the column electrode D3(B) facing the blue discharge cells C(B) in the peripheral portion P3 of the panel display area P (see FIG. 1) is composed only of the main body D3(B)a with an unchanging row-direction width.

As for the other column electrodes facing the red discharge cells C(R) and the green discharge cells C(G), FIG. 14 illustrates the same column electrodes D1(R), D1(G) as those described in the fourth embodiment. However, the column electrodes facing the red discharge cells C(R) and the green discharge cells C(G) in the seventh embodiment may be either the same column electrodes D(R), (D)G as those described in the second embodiment or the same column electrodes D2(R), D2(G) as those described in the sixth embodiment.

In the example described in the eight embodiment, the transparent electrodes X3b(R), Y3b(R), X3b(G), Y3b(G) of the row electrodes X3, Y3 are shaped as in the case of the foregoing sixth embodiment. That is, the area of each of the transparent electrodes X3b(R), Y3b(R), X3b(G), Y3b(G) is greater than that of each of the transparent electrodes X3b (B), Y3b (B) in the central portion P1 and the intermediate portion P2, and the transparent electrodes X3b(R), Y3b(R), X3b(G), Y3b(G) decrease in area by steps from the central portion P1 to the intermediate portion P2 and then to the peripheral portion P3.

The structure of other components of the PDP, the setting of the areas of the transparent electrodes X3b(R), Y3b(R), X3b (G), Y3b(G) and the widened portions of the column electrode D1(R), D1(G) in the central portion P1 and the intermediate portion P2 of the panel display area P, and the like in the eighth embodiment are the same those in the second embodiment.

The PDP of the eighth embodiment can deliver the same technical advantages as those in the PDP according to the second, fourth and sixth embodiments. In addition, even if the discharge intensity of the opposing discharge produced between the row electrode Y3 and the column electrode D3(B) in the blue discharge cell C(B) varies considerably from location to location in the PDPs of the second, fourth and sixth embodiments, the PDP of the eighth embodiment can ensure uniform intensities of the opposing discharge initiated in the blue discharge cells C(B) over the full panel display area P.

The PDP according to each of the aforementioned embodiments is based on a basic idea that a PDP comprises a first substrate and a second substrate facing each other across a discharge space to form a panel screen, a plurality of row electrode pairs that extend in a row direction and are regularly arranged in a column direction on a back-facing face of the first substrate, and a plurality of column electrodes that extend in the column direction and regularly arranged in the row direction on a face of the second substrate facing the first substrate to form unit light emission areas in positions respectively corresponding to intersections with the row electrode pairs in the discharge space and are provided for allowing an opposing discharge across the discharge space to be initiated between the column electrodes and corresponding row electrodes in the row electrode pairs in each unit light emission area, wherein required column electrodes of the plurality of column electrodes regularly arranged in the row direction have portions facing corresponding row electrodes in the row electrode pairs and the portions are set to vary in area in accordance with positions of the corresponding unit light emission areas within the panel screen.

For example, in a PDP in which a black level display is generated only by an opposing discharge initiated between a column electrode and one of a row electrode pair such as a reset discharge and an address discharge (selective erase discharge), the discharge intensity of the opposing discharge may conventionally vary from unit light emission area to unit light emission area located in the panel screen. However, in the PDP according to the embodiments based on the above basic idea, the area of the row-electrode-facing portion of each of the required column electrodes of the plurality of column electrodes regularly arranged in the row direction is determined in accordance with the position of the corresponding unit light emission area within the panel screen. As a result, the in-plane variations in discharge intensity of the opposing discharge are corrected, so that the discharge intensity of the opposing discharge can be made approximately uniform over the full panel screen. In consequence, the occurrence of the in-plane spots in the luminance display generated by the opposing discharge is inhibited, thus making it possible to improve the luminance display quality of the PDP.

The terms and description used herein are set forth by way of illustration only and are not meant as limitations. Those skilled in the art will recognize that numerous variations are possible within the spirit and scope of the invention as defined in the following claims.

What is claimed is:

1. A plasma display panel, comprising:
a first substrate and a second substrate facing each other across a discharge space to form a panel screen;
a plurality of row electrode pairs that extend in a row direction and are regularly arranged in a column direction on a back-facing face of the first substrate, each row electrode pair being made up of a first row electrode and a second row electrode; and
a plurality of column electrodes that extend in the column direction and regularly arranged in the row direction on a face of the second substrate facing the first substrate to form unit light emission areas in positions respectively corresponding to intersections with the row electrode pairs in the discharge space and are provided for allowing an opposing discharge across the discharge space to be initiated between the column electrodes and the corresponding first row electrodes of the respective row electrode pairs in each unit light emission area, wherein required column electrodes of the plurality of column electrodes regularly arranged in the row direction have portions facing the corresponding first row electrodes and the portions are set to vary in area in accordance with positions of the corresponding unit light emission areas within the panel screen.

2. A plasma display panel according to claim 1, wherein the portions of the column electrodes facing the corresponding first row electrode have a largest area in a central portion of the panel screen and decrease in area by steps from the central portion to a peripheral portion of the panel screen.

3. A plasma display panel according to claim 1, wherein the panel screen is divided into three portions, a central portion, an intermediate portion around the central portion, and a peripheral portion around the intermediate portion, and the areas of the portions of the column electrodes facing the corresponding first row electrodes in the unit light emission areas located in the three portions of the panel screen are set in three sizes decreasing by steps from the central portion to the intermediate portion and then to the peripheral portion.

4. A plasma display panel according to claim 1, wherein the area of each of the portions of the column electrodes facing the corresponding first row electrodes and located in a peripheral portion of the panel screen is smaller than the area of each of the portions of the column electrodes facing the corresponding first row electrodes and located in a central portion of the panel screen.

5. A plasma display panel according to claim 1, wherein each of the portions of the column electrodes facing the corresponding first row electrodes is provide with a widened portion having a row-direction width larger than that of the remaining portion of the column electrode as appropriate, and the area of the portion of the column electrode facing the corresponding first row electrode is determined depending on the widened portion.

6. A plasma display panel according to claim 5, wherein
each of the first and second row electrodes constituting each of the row electrode pairs has a row-electrode body extending in the row direction, and a plurality of row-electrode protrusions each extending out from the row-electrode body toward the other row electrode paired therewith in the column direction in a position corresponding to each unit light emission area so as to face the other row electrode across a discharge gap, and
the widened portion of the column electrode faces a region including a leading end of each of the row-electrode protrusions of the first row electrode close to the discharge gap.

7. A plasma display panel according to claim 1, wherein
the unit light emission areas are grouped into three types, the unit light emission areas in which red phosphor layers are respectively provided, the unit light emission areas in which green phosphor layers are respectively provided and the unit light emission areas in which blue phosphor layers are respectively provided, the three unit light emission areas with the red, green and blue phosphor layers forming a pixel, and
the portions of the column electrodes facing the corresponding first row electrodes, located facing the unit light emission areas each of which has the phosphor layer of one of the three colors provided therein and is one of the three unit light emission areas forming each pixel, are set to vary in area in accordance with positions of the corresponding unit light emission areas within the panel screen.

8. A plasma display panel according to claim 7, wherein the column electrode, which has the portions facing the first row electrodes and set to vary in area in accordance with the positions of the corresponding unit light emission areas within the panel screen, is the column electrode facing the unit light emission areas in which the red phosphor layers are respectively provided.

9. A plasma display panel according to claim 7, wherein the column electrode, which has the portions facing the first row electrodes and set to vary in area in accordance with the positions of the corresponding unit light emission areas within the panel screen, is the column electrode facing the unit light emission areas in which the green phosphor layers are respectively provided.

10. A plasma display panel according to claim 7, wherein
the column electrodes, which have the portions facing the first row electrodes and set to vary in area in accordance with the positions of the corresponding unit light emission areas within the panel screen, are the column electrodes respectively facing the unit light emission areas in which the red phosphor layers are respectively provided and the unit light emission areas in which the green phosphor layers are respectively provided, and
in the column electrode located facing the unit light emission areas in which the blue phosphor layers are respectively provided, the portions facing the first row electrodes have a uniform area.

11. A plasma display panel according to claim 10, wherein in each of the column electrodes facing the unit light emission areas in which the red phosphor layers are provided, the unit light emission areas in which the green phosphor layers are provided and the unit light emission areas in which the blue phosphor layers are provided, the portions facing the first row electrodes are set to vary in area in accordance with positions of the corresponding unit light emission areas within the panel screen.

12. A plasma display panel according to claim 1, wherein each of the first and second row electrodes constituting each row electrode pair has discharge-initiating portions, and the discharge-initiating portions facing required unit light emission areas of the unit light emission areas are set to vary in area in accordance with positions of the corresponding unit light emission areas within the panel screen.

13. A plasma display panel according to claim 12, wherein both of each of the discharge-initiating portions of each of the first and second row electrodes and each of the portions of the column electrodes facing the corresponding discharge-initiating portion of the first row electrode have largest areas in a central portion of the panel screen and decrease in area by steps from the central portion to a peripheral portion of the panel screen.

14. A plasma display panel according to claim 12, wherein
the panel screen is divided into three portions, a central portion, an intermediate portion around the central portion, and a peripheral portion around the intermediate portion, and
the areas of the discharge-initiating portions of the first and second row electrodes and the portions of the column electrodes facing the corresponding discharge-initiating portions of the first row electrodes in the unit light emission areas located in the three portions of the panel screen are set in three sizes decreasing by steps from the central portion to the intermediate portion and then to the peripheral portion.

15. A plasma display panel according to claim 12, wherein
each of the first and second row electrodes constituting each of the row electrode pairs has a row-electrode body extending in the row direction, and a plurality of row-electrode protrusions each extending out from the row-electrode body toward the other row electrode paired therewith in the column direction in a position corresponding to each unit light emission area so as to face the other row electrode across a discharge gap, and
the row-electrode protrusions facing the required unit light emission areas from among the plurality of row-electrode protrusions of the row electrodes are set to vary in area in accordance with the positions of the corresponding unit light emission areas within the panel screen.

16. A plasma display panel according to claim 12, wherein each of the portions of the column electrodes facing the corresponding first row electrodes is provide with a widened portion having a row-direction width larger than that of the remaining portion of the column electrode as appropriate, and the area of the portion of the column electrode facing the corresponding discharge-initiating portion of the first row electrode is determined depending on the widened portion.

17. A plasma display panel according to claim 16, wherein
each of the first and second row electrodes constituting each of the row electrode pairs has a row-electrode body extending in the row direction, and a plurality of row-electrode protrusions each extending out from the row-electrode body toward the other row electrode paired therewith in the column direction in a position corresponding to each unit light emission area so as to face the other row electrode across a discharge gap, and
the widened portion of the column electrode faces a region including a leading end of each of the row-electrode protrusions of the first row electrode close to the discharge gap.

18. A plasma display panel according to claim 12, wherein
the unit light emission areas are grouped into three types, the unit light emission areas in which red phosphor layers are respectively provided, the unit light emission areas in which green phosphor layers are respectively provided and the unit light emission areas in which blue phosphor layers are respectively provided, the three unit light emission areas with the red, green and blue phosphor layers forming a pixel, and
discharge-initiating portions of the row electrodes and the portions of the column electrodes facing the first row electrodes, which are located facing the unit light emission areas each having the phosphor layer of one of the three colors provided therein and being one of the three unit light emission areas forming each pixel, are set to vary in area in accordance with positions of the corresponding unit light emission areas within the panel screen.

19. A plasma display panel according to claim 18, wherein the discharge-initiating portions of the row electrodes and the column electrodes, which are set to vary in area in accordance with the positions of the corresponding unit light emission areas within the panel screen, are the discharge-initiating portions of the row electrodes and the column electrodes facing the unit light emission areas in which the red phosphor layers are respectively provided.

20. A plasma display panel according to claim 18, wherein the discharge-initiating portions of the row electrodes and the column electrodes, which are set to vary in area in accordance with the positions of the corresponding unit light emission areas within the panel screen, are the discharge-initiating portions of the row electrodes and the column electrodes facing the unit light emission areas in which the green phosphor layers are respectively provided.

21. A plasma display panel according to claim 18, wherein
the discharge-initiating portions of the row electrode and the column electrodes, which are set to vary in area in accordance with the positions of the corresponding unit light emission areas within the panel screen, are the discharge-initiating portions of the row electrodes and the column electrodes facing the unit light emission areas in which the green phosphor layers are respectively provided and the unit light emission areas in which the green phosphor layers are respectively provided, and
the discharge-initiating portions of the row electrodes and the column electrodes facing the unit light emission areas in which the blue phosphor layers are respectively provided have uniform areas.

22. A plasma display panel according to claim 18, wherein all the discharge-initiating portion of the row electrodes and all the column electrodes facing the unit light emission areas in which the red phosphor layers are provided, the unit light emission areas in which the green phosphor layers are provided and the unit light emission areas in which the blue phosphor layers are provided, are set to vary in area in accordance with the positions of the corresponding unit light emission areas within the panel screen.
